(19) United States
(12) Patent Application Publication
(10) Pub. No.: US 2015/0034862 A1
(43) Pub. Date: Feb. 5, 2015

(54) PROCESS FOR PRODUCING A POSITIVE ELECTRODE MIX AND A LITHIUM ION SECONDARY BATTERY

(71) Applicant: Hitachi Automotive Systems, Ltd., Hitachinaka-shi, Ibaraki (JP)

(72) Inventor: Motonari Kifune, Hitachinaka (JP)

(73) Assignee: Hitachi Automotive Systems, Ltd., Hitachinaka-shi, Ibaraki (JP)

(21) Appl. No.: 14/379,459

(22) PCT Filed: Jan. 11, 2013
(86) PCT No.: PCT/JP2013/050348

§ 371 Date: Aug. 18, 2014

(30) Foreign Application Priority Data
Mar. 16, 2012 (JP) 2012-060550

(51) Int. Cl. H01M 4/505; H01M 4/525; H01M 4/62; H01M 10/0525

(52) U.S. Cl. CPC H01M 4/505; H01M 10/0525; H01M 4/525; H01M 4/623; H01M 2004/028
USPC 252/182.1

(57) ABSTRACT

To obtain a process for producing a positive electrode mix capable of producing, in a short time, a positive electrode mix in a stable slurry state containing a high nickel lithium composite oxide with less variation of viscosity change with time. A lithium composite oxide at high nickel content is kneaded with at least one of a conduction aid and a binder resin in a gaseous carbon dioxide atmosphere in a kneading step. Thus, a treatment of oxidizing lithium hydroxide in the lithium composite oxide is proceeded efficiently and a positive electrode mix in a stable slurry state with less variation of viscosity change with time is produced in a short time.

### TECHNICAL FIELD

The present invention relates to a process for producing a positive electrode mix used for manufacturing a positive electrode, for example, of an onboard lithium ion secondary battery, and a lithium ion secondary battery.

### BACKGROUND ART

Along with actualization of environmental problems such as global warming, reduction of gaseous carbon dioxide emission from automobiles has been demanded, and development has been progressed at a fast pace for electric cars using electric energy as a power and hybrid cars that recover an energy upon deceleration of the cars and utilizing the energy as a portion of the power. Particularly, lithium ion secondary batteries utilizing occluding and releasing reaction of lithium ions at electrodes have been noted as secondary batteries used for cars.

Positive electrode active materials used in lithium ion secondary batteries typically include composite oxides mainly comprising lithium and a transition metal such as lithium cobaltate and lithium nickelate (hereinafter referred to as a lithium composite oxide). Since lithium cobaltate has no room for the improvement of energy density and uses cobalt which is poor in resources and expensive, materials of using nickel capable of improving the energy density and inexpensive manganese as a transition metal as a substitute of cobalt have been developed.

As the configuration of an electrode of a lithium ion secondary battery, it has been known to form a mix layer containing an active material on the surface of a metal foil that constitutes a collector has been known. The mix layer is generally formed by dispersing and diluting an active material, a conduction aid, a binder resin, etc. in a solvent, coating and drying a slurried mix on the surface of a metal foil and then compression forming the same by a press.

For onboard lithium ion secondary batteries, reduction of cost and increase of energy density are further demanded. Then, it has been studied to increase the ratio of nickel in lithium composite oxides as a positive electrode active material thereby reducing the cost and increasing the energy density.

However, increase of the nickel ratio involves a problem that the viscosity of the positive electrode mix increases greatly to cause so-called gelation during production process to result a difficulty in coating the positive electrode mix as slurry on a metal foil. Since a lithium composite oxide at a high nickel ratio (hereinafter referred to as a high nickel lithium composite oxide) has a property that lithium hydroxide tends to be precipitated on the surface or the crystal boundary of the active material and lithium hydroxide has an effect of gelling the binder resin in the slurry, the problem described above is caused.

Patent literature 1 proposes placing an active material in a gaseous carbon dioxide atmosphere before the kneading step of slurrying a mix that contains an active material thereby applying an oxidizing treatment to lithium hydroxide of the lithium composite oxide.

### CITATION LIST

### Patent Literature

Patent Literature 1: Japanese Patent Unexamined Application Publication No. 2012-3891

### SUMMARY OF THE INVENTION

### Technical Problem

According to the technique described in the patent literature 1, it is necessary to place an active material in a gaseous carbon dioxide atmosphere at least for two hours or more and the number of steps is increased by one compared with the existent method. As a result, this involves a problem that the production lead time becomes longer.

The present invention has been accomplished in view of such a problem and intends to provide a process for producing a positive electrode mix capable of producing a positive electrode mix which is a stable high nickel lithium composite oxide in a slurry state with less variation of viscosity change with time in a short time, as well as a lithium ion secondary battery at a low cost and having high energy density by using the positive electrode mix described above.

### Solution to Problem

The present application includes plural means to solve the problem and, as an example thereof, a process for producing a positive electrode mix of the present invention includes a kneading step of kneading a lithium composite oxide represented by the following compositional formula (1) with at least one of a conduction aid and a binder resin characterized by kneading them in a gaseous carbon dioxide atmosphere:

LiₐNiₓCo_{y}Mn_{1-x-y}O_{b} (1)

where (x/y)>4.0, 0.4≦x<1.0, 0<y≦0.2 (0.9≦a≦1.1, 1.9≦b≦2.1)

### Advantageous Effects of Invention

According to the present invention, an oxidizing treatment for lithium hydroxide of a lithium composite oxide can be proceeded efficiently and a stable positive mix in a slurry state with less variation of viscosity change with time by using a high nickel lithium composite oxide as a positive electrode active material can be produced in a short time, and a lithium ion secondary battery at low cost and having high energy density using the high nickel lithium composite oxide can be obtained.

### BRIEF DESCRIPTION OF DRAWINGS

FIG. 1 is an exploded perspective view illustrating a partially broken state of a cylindrical lithium ion secondary battery.

FIG. 2 is a flow chart that explains a process for producing a positive electrode.

FIG. 3 is a conceptual view for explaining a kneading step.

FIG. 4 is a graph showing a relation between a gaseous carbon dioxide processing time and a weight ratio of lithium hydroxide contained in an active material.

### DESCRIPTION OF EMBODIMENTS

A preferred embodiment of the present invention is to be described specifically.

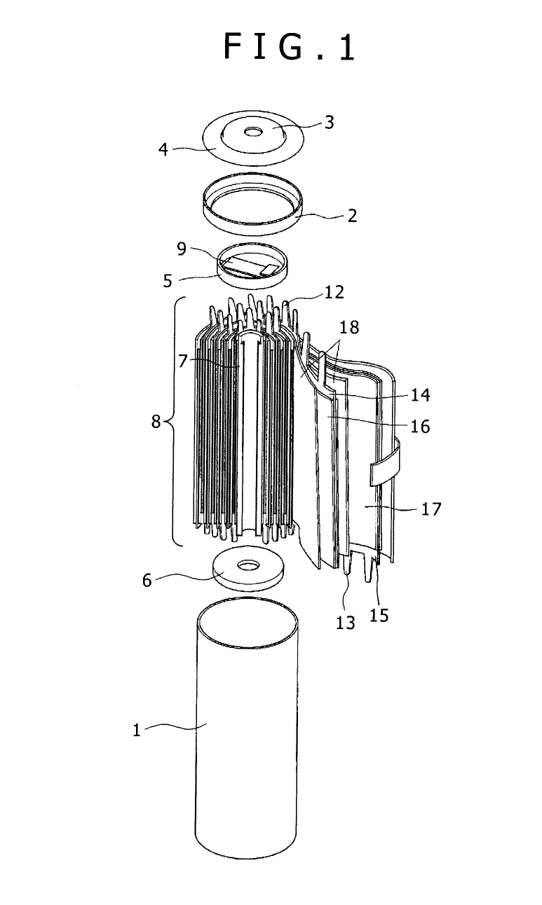

FIG. 1 illustrates an exploded perspective view of a cylindrical battery as an example of an onboard lithium ion secondary battery produced by using a positive electrode mix in this embodiment. The positive electrode mix in this embodiment is utilized not only to the cylindrical battery but also to various batteries such as a square battery.

In FIG. 1, a positive electrode collector 14 is a metal foil such as formed of aluminum and a positive electrode mix layer 16 is formed on both surfaces thereof. A plurality of positive electrode tabs 12 are provided to an upper longer side of the positive electrode collector 14 in the drawing. A negative electrode collector 15 is a thin film of a metal such as copper and a negative electrode mix layer 17 is formed on both surfaces thereof. A plurality of negative electrode tabs 13 are disposed to a lower longer side of the negative electrode collector 15 in the drawing.

The positive electrode collector 14 and the negative electrode collector 15 are wound by way of a porous and insulating separator 18 around an axial core 7 made of a resin, and a separator 18 at the outermost circumference is fixed with a tape to form an electrode group 8. An innermost circumference in contact with the axial core 7 is the separator 18 and the outermost circumference is the separator 18 that covers the negative electrode collector 15 and the negative electrode mix 17.

A positive electrode collector plate 5 and a negative electrode collector plate 6 are fixed by fitting on both ends of the tubular axial core 7. A positive electrode tab 12 is welded to the positive electrode collector plate 5, for example, by a supersonic welding method. In the same manner, a negative electrode tab 13 is welded to the negative electrode collector plate 6, for example, by the supersonic welding method. In the inside of the battery container 1 that also serves as a negative electrode terminal, the positive electrode collector plate 5 and the negative electrode collector plate 6 are housed being attached to the electrode group 8 that is wound around the axial core 7 made of the resin as an axis.

In this case, an electrolyte is also injected in the battery container 1. Further, a gasket 2 is interposed between the battery container 1 and an upper lid case 4 and the gasket 2 seals the opening and also provides electric insulation.

A conductive upper lid is provided above the positive electrode collector plate 5 so as to seal the opening of the battery container 1. The upper lid comprises an upper lid 3 and an upper lid case 4. Since one end of the positive electrode lead 9 is connected to the upper lid case 4 and the other end is welded to the positive electrode collector plate 5, the upper lid and the positive electrode of the electrode group 8 are electrically connected.

The positive electrode mix layer 16 has a positive electrode active material, a positive electrode conduction aid, and a positive electrode binder resin. As the positive electrode active material, a high nickel lithium composite oxide represented by the following compositional formula (1) is used:

LiₐNiₓCo_{y}Mn_{1-x-y}O_{b} (1)

where (x/y)>4.0, 0.4≦x<1.0, 0<y≦0.2 (0.9≦a≦1.1, 1.9≦b≦2.1)

The positive electrode conduction aid includes, for example, graphite and acetylene black. The positive electrode binder resin includes, for example, polyvinylidene fluoride (PVDF) and fluoro rubber. The positive electrode binder resin is not particularly restricted so long as the resin can bind the positive electrode active material, the positive electrode conduction aid, and the positive electrode collector and is not deteriorated substantially when the resin is in contact with the electrolyte.

The negative electrode mix layer 17 usually has a negative electrode active material, a negative electrode binder resin, and a viscosity improver. The negative electrode mix layer 17 may also have a negative electrode conduction aid such as acetylene black. The negative electrode active material includes, for example, carbonaceous materials such as graphite, soft carbon, and hard carbon. As the negative electrode binder resin, PVDF, etc. can be used or styrene-butadiene copolymer rubber (SBR), etc. are also applicable in the same manner as the positive electrode.

The positive electrode mix layer 16 and the negative electrode mix layer 17 are formed by preparing a liquid dispersion of a material that forms the mix in a slurry state, coating and drying the slurry mix on a metal foil, drying and then pressing the same.

An example of the coating method includes, for example, a slit die coating method and a roll coating method. As the solvent for the liquid dispersion, N-methyl pyrrolidone (NMP), water, etc. can be used. Further, the drying method includes, for example, hot blow circulation, infrared heating, and a method combining them. The pressing method includes pressing and compressing both surfaces of the electrode by a cylindrical metal roller from both surfaces of the electrode.

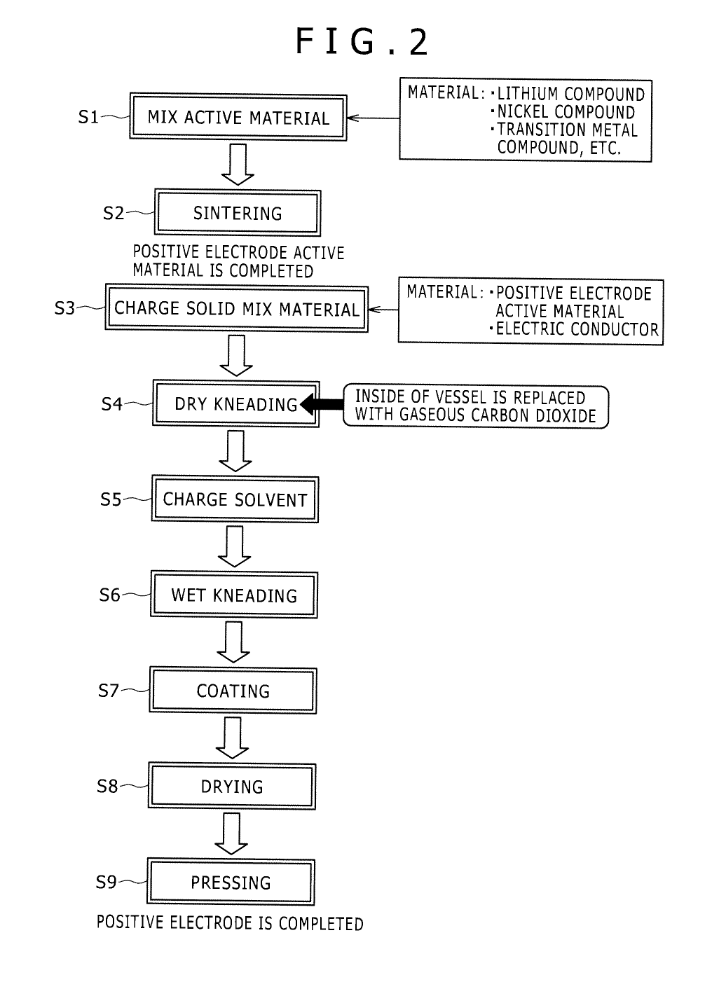

FIG. 2 is a flow chart that explains a process for producing the positive electrode which illustrates each of the steps from the preparation of the positive electrode active material to the completion of the positive electrode. The process for producing the positive electrode includes, as illustrated in FIG. 2, an active material mixing step (S1), a sintering method (S2), a solid mix material charging step (S3), a dry kneading step (S4), a solvent charging step (S5), a wet kneading step (S6), a coating step (S7), a drying step (S8), and a pressing step (S9).

In the active material mixing step (S1), each of the materials, for example, a lithium compound, a nickel compound and other transition metal compound are mixed. Then, in the sintering step (S2), a mixture mixed in the mixing step is sintered. By the sintering step, a high nickel lithium composite oxide as the positive electrode active material is formed completely.

Then, in the solid mix material charging step (S3), the positive electrode active material and the conduction aid are charged in a mixing vessel. Then, in the dry kneading step (S4), the positive electrode active material and the conduction aid are subjected to dry kneading in a gaseous carbon dioxide atmosphere, to fowl a dry mixture. Then, a solvent containing the binder resin is charged in the mixing vessel (S5) and a wet kneading step (S6) of kneading a dry mixture and a solvent is performed.

In the wet kneading step (S6), the mixture and the solvent are kneaded in an inert gas atmosphere to form a positive electrode mix in a slurry state as a wet mixture. Then, a positive electrode mix is coated on both surfaces of the positive electrode collector (coating step), dried (drying step) and pressed after drying to complete positive electrode having a positive electrode mix layer (pressing step).

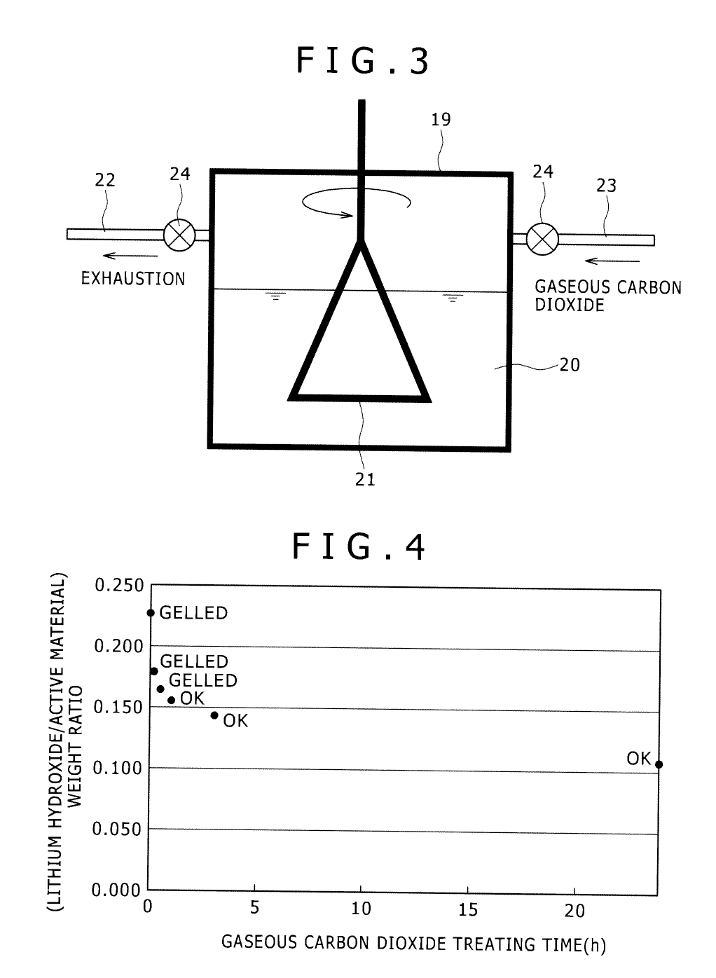

FIG. 3 is a conceptual view that explains the kneading step. In the dry kneading step, a positive electrode active material and a conduction aid are charged each by a predetermined amount in a kneading vessel 19, and the inside of the kneading vessel 19 is replaced with a gaseous carbon dioxide atmosphere. The inside of the kneading vessel 19 is replaced with the gaseous carbon dioxide atmosphere by discharging a gas in the kneading vessel 19 from an exhaust pipe 22 by operating a valve 24 of the exhaust pipe 22 and introducing gaseous carbon dioxide from a gas introduction pipe 23 to the kneading vessel 19 by operating a valve 24 of the gas introduction pipe 23.

Then, a kneading blade 21 is rotated in a state where the inside of the kneading vessel 19 is replaced with the gaseous carbon dioxide atmosphere and the mix materials (positive electrode active material and conduction aid) 20 in the kneading vessel 19 are mixed and dispersed to form a dry mixture. By the dry kneading step, agglomerates of the positive electrode active material can be disintegrated to expose the positive electrode active material sufficiently to gaseous carbon dioxide. Accordingly, an oxidizing treatment of lithium hydroxide precipitated to the active material surface or the crystal boundary of the positive electrode active material can be promoted and treatment can be performed in a short time.

In the wet kneading step, a solvent is charged into the kneading vessel 19 succeeding to the dry kneading step and the inside of the kneading vessel 19 is replaced with an atmosphere of an inert gas such as an argon gas. The inside of the kneading vessel 19 is replaced with the inert gas atmosphere by operating the valve 24 of the exhaust pipe 22 and the valve 24 of the gas introduction pipe 23 in the same manner as that for the gaseous carbon dioxide. Then, the kneading blade 21 is rotated in a state where the inside of the kneading vessel 19 is replaced with the inert gas atmosphere and the dry kneaded product and the solvent are kneaded in the kneading vessel 19 to form a positive electrode mix in a slurry state as a wet kneaded product.

According to the process for producing the positive electrode mix in this embodiment, since lithium hydroxide precipitated to the active material surface or crystal boundary of the positive electrode active material is oxidized more proactively into a more stable lithium carbonate, stable positive mix in a slurry state with less viscosity change and with no gelation can be produced even when a high nickel lithium composite oxide is used as the positive electrode active material.

In the embodiment described above, it has been explained for an example of replacing the inside of the kneading vessel 19 with the gaseous carbon dioxide atmosphere in the dry kneading step (S4), but this is not limitative and kneading may be performed, for example, by kneading while replacing the inside of the kneading vessel 19 with an atmosphere of an inert gas such as Ar in the dry kneading step (S4) and kneading may be performed in the wet kneading step (S6) by replacing the inside of the kneading vessel 19 with the gaseous carbon dioxide atmosphere. In this case, if a solvent containing a binder resin is charged in the kneading vessel so as to perform the wet kneading step (S6) and left as it is, since lithium hydroxide is in a state precipitated to the active material surface and the crystal boundary of the positive electrode active material, gelation initiates 2 to 3 hours after the charging. Accordingly, it is necessary to start the kneading before initiation of gelation, for example, one hour after the charging. Further, as other method, kneading may be performed also by replacing the inside of the kneading vessel 19 with the gaseous carbon dioxide atmosphere in both of the dry kneading step (S4) and the wet kneading step (S6).

### EXAMPLE

Then, a positive electrode mix slurry for an onboard non-aqueous electrolyte secondary battery was manufactured as described below and the effect of the invention was investigated.

At first, a high nickel lithium composite oxide represented by the following compositional formula (1) was used as the positive electrode active material, and a positive electrode conduction aid was charged in a kneading vessel (weight ratio 89:11):

LiₐNiₓCo_{y}Mn_{1-x-y}O_{b} (1)

where (x/y)>4.0, 0.4≦x<1.0, 0<y≦0.2 (0.9≦a≦1.1, 1.9≦b≦2.1) (a=1.0, x=0.45, y=0.1, and b=2.0 for the oxide used in the example).

After charging, the gas atmosphere in the inside of the kneading vessel was replaced with 10 vol % of gaseous carbon dioxide and a remaining part of Ar as an inert gas and dry-kneading was performed for an optional time. After dry kneading, a portion of the powder was taken out and the amount of lithium hydroxide precipitated onto the active material surface and the crystal boundary was measured subsequently.

Then, PVDF and N-methyl-2-pyrrolidone (NMP) were charged as a positive electrode binder resin, i.e., a remaining slurry mix material, and wet-kneaded to produce a positive electrode mix in a slurry state. Kneading was performed at a room temperature by using a planetary mixer to a final solid content of the coating material of 65% by weight.

The fluidity of the produced positive electrode mix was observed occasionally for 168 hours just after the production thereof and slurry stability was investigated (if the slurry was gelled or not).

The amount of lithium hydroxide was measured by a neutralizing titration. A powder sampled partially after the dry kneading was dispersed in water and subjected to neutralizing titration by using hydrochloric acid. Then, the amount of lithium hydroxide precipitated to the active material surface and the crystal boundary was determined in view of a first neutral point and a second neutral point and represented as a weight ratio of lithium hydroxide to the active material.

Table 1 shows the result of determination. Further, FIG. 4 illustrates a relation between a gaseous carbon dioxide treating time and the weight ratio (wt %) of lithium hydroxide contained in the active material, and gelation.

TABLE 1

| Kneading time in gaseous | | Lithium hydroxide/active |
|---|---|---|
| carbon dioxide atmosphere | Slurry | material weight ratio |
| (h) | stability | (wt %) |
| 0 | Gelled | 0.228 |
| 0.16 | Gelled | 0.18 |
| 0.5 | Gelled | 0.165 |
| 1 | OK | 0.156 |
| 3 | OK | 0.144 |
| 21 | OK | 0.108 |

As shown in Table 1, when dry kneading is performed in a gaseous carbon dioxide atmosphere for one hour or more, the mass ratio of lithium hydroxide precipitated to the surface of the positive electrode active material and the crystal boundary to the active material is 0.156 or less ((mass of lithium hydroxide/mass of active material)≦0.156), and a stable positive electrode mix in a slurry state with less viscosity change with time and with no gelation could be produced, and a battery could be manufacture by using such a positive electrode mix. One hour of dry kneading time is sufficient and, with a view point of mass production, it is preferably as short as possible. For reliably preventing gelation, the dry kneading time is preferably one hour or more and less than 2 hours for doubled safety factor.

Further, in the example described above, while the gas atmosphere in the kneading vessel was replaced with 10 vol % gaseous carbon dioxide in the dry kneading step, it may suffice that the gas concentration of the gaseous carbon dioxide is 10 vol % or more to 100 vol % or less. When the concentration of the gaseous carbon dioxide is 100 vol %, use of a relatively expensive Ar can be saved, which is advantageous in view of the cost.

Inside of the kneading vessel during the kneading step is generally replaced with an inert gas such as Ar. According to the process for producing the positive electrode mix in this embodiment, the inert gas can be merely replaced with less expensive gaseous carbon dioxide and high nickel lithium composite oxide can be obtained without increasing the installation cost and in a short time, and a secondary battery of low cost and high energy density can be obtained.

While the present invention has been described specifically with reference to the preferred embodiment of the invention, the invention is not restricted to the configuration of the embodiment described above but can be changed variously for the design within a range not departing the gist of the invention. For example, an example of the electrode for the lithium ion secondary battery is shown in the embodiment described above but this can be used also for the electrode of a primary battery such as lithium ion battery or the electrode of a nickel hydrogen secondary battery. Further, the electrode can be used not being restricted to the lithium ion battery but also as an electrode for other primary batteries and the secondary batteries.

### LIST OF REFERENCE SIGNS

1 battery container
2 gasket
3 upper lid
4 upper lid case
5 positive electrode collector plate
6 negative electrode collector plate
7 axial core
8 electrode group
9 positive electrode lead
12 positive electrode tab
13 negative electrode tab
14 positive electrode collector
15 negative electrode collector
16 positive electrode mix
17 negative electrode mix
18 separator
19 kneading vessel
20 mix material
21 kneading blade
22 exhaust pipe
23 gas introduction pipe
24 valve

1. A process for producing a positive electrode mix in which a lithium composite oxide represented by the following compositional formula (1) is kneaded with at least one of a conduction aid and a binder resin, characterized in that they are kneaded in a gaseous carbon dioxide atmosphere:
LiₐNiₓCo_{y}Mn_{1-x-y}O_{b} (1)
where (x/y)>4.0, 0.4≦x<1.0, 0<y≦0.2 (0.9≦a≦1.1, 1.9≦b≦2.1)

2. The process for producing the positive electrode mix according to claim 1 characterized in that
the kneading step includes a dry kneading step of kneading the lithium composite oxide and the conduction aid and a wet kneading step of kneading a kneaded product kneaded by the dry kneading step and the binder resin, in which
kneading in the gaseous carbon dioxide atmosphere is performed in at least one of the dry kneading step and the wet kneading step.

3. The process for producing the positive electrode mix according to claim 2, characterized in that
the kneading time is one hour or more when the kneading in the gaseous carbon dioxide atmosphere is performed in the dry kneading step.

4. The process for producing the positive electrode mix according to claim 2, characterized in that
when kneading in the gaseous carbon dioxide atmosphere is performed in the wet kneading step, the kneading is started within one hour after the charging of the binder resin to the kneaded product.

5. The process for producing the positive electrode mix according to claim 3, characterized in that
the gas concentration of the gaseous carbon dioxide is 10 vol % or more to 100 vol % or less.

6. The process for producing the positive electrode mix according to claim 2, characterized in that
when kneading in the gaseous carbon dioxide atmosphere is performed in the dry kneading step, the kneading is performed in the kneading step till the weight ratio of lithium hydroxide contained in the mixture and the lithium composite oxide is lowered to 0.156 or less.

7. A lithium ion secondary battery characterized by comprising an electrode plate using the positive electrode mix produced by the production process according to claim 1.

8. The process for producing the positive electrode mix according to claim 4, characterized in that
the gas concentration of the gaseous carbon dioxide is 10 vol % or more to 100 vol % or less.
